(19) United States
(12) Patent Application Publication
(10) Pub. No.: US 2026/0114623 A1
(43) Pub. Date: Apr. 30, 2026

(54) RECYCLABLE ERGONOMIC SEAT

(71) Applicant: MiEN Company, Grand Rapids, MI (US)

(72) Inventors: Remco Bergsma, Grand Rapids, MI (US); Avron Levin, Dallas, TX (US)

(21) Appl. No.: 19/431,969

(22) Filed: Dec. 23, 2025

Related U.S. Application Data
(63) Continuation-in-part of application No. 19/250,007, filed on Jun. 25, 2025.
Application No. 19/250,007 is a continuation of application No. 19/240,840, filed on Jun. 17, 2025.
(60) Provisional application No. 63/660,974, filed on Jun. 17, 2024.

(51) Int. Cl. A47C 3/16; A47C 5/12; A47C 7/02; A47C 7/18; A47C 31/11; B32B 3/04; B32B 5/02; B32B 5/18; B32B 5/24; B32B 5/32

(52) U.S. Cl. CPC A47C 3/16; A47C 5/125; A47C 7/021; A47C 7/18; A47C 31/11; B32B 3/04; B32B 5/022; B32B 5/18; B32B 5/245; B32B 5/32; B32B 2266/025; B32B 2266/08; B32B 2307/744; B32B 2479/00

(57) ABSTRACT

A seat includes a cushion structure having an inner foam layer including polyethylene foam and an outer cushion layer including recycled carpet fiber material. A removable outer covering encases the cushion structure. The outer covering includes an upper section and a lower section joined by a releasable fastener. The lower section includes a non-slip surface that extends up a portion of the sides of the seat. The inner foam layer may include a plurality of foam layers stacked atop one another. The outer cushion layer may include a top layer, a bottom layer, and a sleeve that surrounds the sides of the inner foam layer. The sleeve may be formed from a rectangular sheet of recycled carpet fiber material with opposed ends secured together to form a continuous loop.

### CROSS-REFERENCE TO RELATED APPLICATIONS

This application is a continuation-in-part of U.S. application Ser. No. 19/250,007, filed Jun. 25, 2025, which is a continuation of U.S. application Ser. No. 19/240,840, filed Jun. 17, 2025, which claims priority to U.S. Application No. 63/660,974, filed Jun. 17, 2024, which are hereby incorporated by reference in their entirety.

### BACKGROUND

### 1. Field of the Invention

The present disclosure relates to seating furniture, and more particularly to a recyclable ergonomic seat with a modular construction designed for comfort, sustainability, and ease of maintenance.

### 2. Description of the Prior Art

Seating furniture plays a crucial role in providing comfort and support for individuals in various settings, from homes and offices to public spaces. Over the years, there has been a growing emphasis on ergonomic design to enhance user comfort and promote better posture during extended periods of sitting. Additionally, environmental concerns have led to increased interest in sustainable and recyclable materials for furniture construction.

Traditional seating often relies on non-recyclable materials such as polyurethane foam, which can contribute to environmental waste when the furniture reaches the end of its lifecycle. Furthermore, many existing seat designs lack modularity, making maintenance, cleaning, and replacement of individual components challenging for users.

Another common issue with conventional seating is the tendency for cushions to lose their shape and support over time, leading to decreased comfort and potentially necessitating premature replacement of the entire piece of furniture. This problem is exacerbated by designs that do not allow for easy rotation or flipping of cushions to distribute wear evenly.

There is a need for seating solutions that address these concerns while maintaining comfort, durability, and aesthetic appeal. Innovations in materials science and manufacturing techniques offer opportunities to create more sustainable and user-friendly seating options that can adapt to changing consumer preferences and environmental standards.

### SUMMARY

According to an aspect of the present disclosure, a seat is provided. The seat includes a cushion structure having an inner foam layer comprising polyethylene foam and an outer cushion layer comprising recycled carpet fiber material. The seat also includes a removable outer covering encasing the cushion structure. The outer covering includes an upper section and a lower section joined by a releasable fastener. The lower section comprises a non-slip surface that extends up a portion of the sides of the seat.

According to other aspects of the present disclosure, the seat may include one or more of the following features. The inner foam layer may comprise a plurality of foam layers stacked atop one another. The outer cushion layer may comprise a top layer, a bottom layer, and a sleeve that surrounds the sides of the inner foam layer. The sleeve may be formed from a rectangular sheet of recycled carpet fiber material with opposed ends secured together to form a continuous loop. The releasable fastener may comprise a zipper that extends around a perimeter of the seat. The inner foam layer may comprise closed-cell polyethylene foam that provides water resistance and structural support. The inner foam layer and the outer cushion layer may be held together without the use of adhesives. The recycled carpet fiber material may comprise waste carpet material that has been shredded, filtered, cleaned, and thermally bonded with an olefin fiber binder to form a non-woven material.

According to another aspect of the present disclosure, a seat is provided. The seat includes a cushion structure having an inner foam layer comprising polyethylene foam and an outer cushion layer comprising recycled carpet fiber material. The outer cushion layer surrounds and forms a jacket around the inner foam layer without the use of adhesives. The outer cushion layer includes a top layer positioned above the inner foam layer, a bottom layer positioned below the inner foam layer, and a sleeve wrapping around sides of the inner foam layer. The seat also includes an outer covering encasing the cushion structure. The outer covering includes an upper section and a lower section.

According to other aspects of the present disclosure, the seat may include one or more of the following features. The polyethylene foam of the inner foam layer may be sourced from previously recycled material. The inner foam layer may comprise a plurality of foam layers stacked atop one another. The sleeve of the outer cushion layer may be formed from a rectangular sheet of recycled carpet fiber material with opposed ends secured together to form a continuous loop. The upper section and the lower section may be joined by a releasable fastener comprising a zipper that extends around a perimeter of the seat. The lower section of the outer covering may comprise a non-slip surface that extends up a portion of the sides of the seat. The outer covering may be removable. The recycled carpet fiber material may comprise waste carpet material that has been shredded, filtered, cleaned, and thermally bonded with an olefin fiber binder to form a non-woven material. The recycled carpet fiber material may be treated with borate compounds to prevent mold and mildew.

According to another aspect of the present disclosure, a seat is provided. The seat includes a cushion structure having an outer cushion layer comprising recycled carpet fiber material. The recycled carpet fiber material comprises waste carpet material that has been shredded, filtered, cleaned, and thermally bonded to form a non-woven material. The seat also includes a removable outer covering encasing the cushion structure.

According to other aspects of the present disclosure, the seat may include one or more of the following features. The cushion structure may further comprise an inner foam layer comprising polyethylene foam, and the outer cushion layer may surround and form a jacket around the inner foam layer. The inner foam layer and the outer cushion layer may be held together without the use of adhesives. The recycled carpet fiber material may be thermally bonded with an olefin fiber binder. The recycled carpet fiber material may be treated with borate compounds to prevent mold and mildew.

For a more complete understanding, reference is made to the following detailed description and accompanying drawings. In the drawings, like reference characters refer to like parts throughout the views in which:

### BRIEF DESCRIPTION OF THE DRAWINGS

FIG. 1 illustrates an isometric view of a seat with an outer covering, in accordance with an embodiment of the disclosure;

FIG. 2 illustrates an exploded view of a cushion structure for a seat, in accordance with an embodiment of the disclosure;

FIG. 3 illustrates an enlarged view of a lower section of a seating structure, in accordance with an embodiment of the disclosure;

FIG. 4 illustrates an isometric view of a triangular seat, in accordance with an embodiment of the disclosure; and

FIG. 5 illustrates an isometric view of a seat with a rounded corner, in accordance with an embodiment of the disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a recyclable ergonomic seat designed with a focus on sustainability, comfort, and modularity. The seat comprises a cushion structure and a removable outer covering. The cushion structure may include an inner foam layer and an outer cushion layer. The removable outer covering encases the cushion structure, providing protection and aesthetic appeal while allowing for easy maintenance and replacement.

In some cases, the inner foam layer of the cushion structure may be composed of a recyclable material, such as polyethylene foam. The outer cushion layer may be made from a different material, such as polyurethane foam or recycled denim batting, to provide additional comfort and support. This combination of materials allows for a balance between structural integrity and ergonomic comfort.

The removable outer covering may be designed to fit snugly over the cushion structure, enhancing the seat's appearance while also facilitating easy removal for cleaning or replacement. In some cases, the outer covering may include separate sections joined by a releasable fastener, allowing for partial removal or replacement of specific areas of the covering.

The modular design of the seat enables easy disassembly, which may facilitate recycling of individual components at the end of the product's life cycle. This approach to construction aligns with sustainable manufacturing practices and supports circular economy principles.

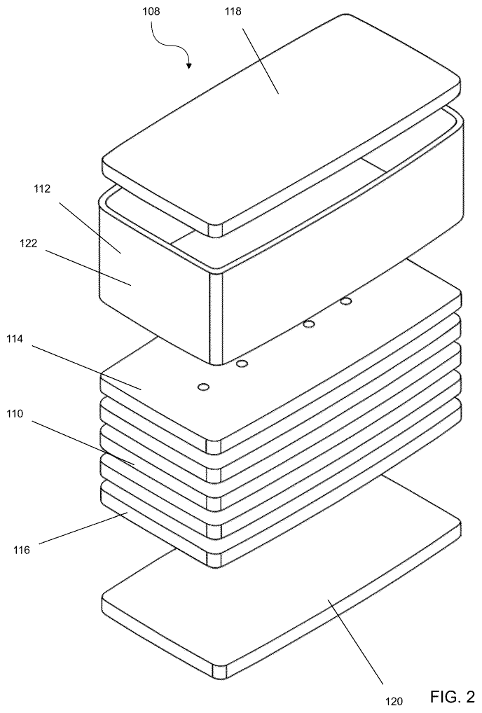

FIG. 2 depicts an exploded view of a cushion structure 108. The cushion structure 108 includes an inner foam layer 110 and an outer cushion layer 112.

In some cases, the inner foam layer 110 comprises polyethylene foam. The polyethylene foam may be closed-cell polyethylene foam that provides water resistance and structural support. In some implementations, the polyethylene foam of the inner foam layer 110 may be sourced from previously recycled material.

The inner foam layer 110 may comprise a core 114. In some cases, the inner foam layer 110 comprises a plurality of foam layers 116 stacked atop one another. The plurality of foam layers 116 may form a block-like structure.

The outer cushion layer 112 surrounds and forms a jacket around the inner foam layer 110. In some implementations, the outer cushion layer 112 comprises polyurethane foam. In other implementations, the outer cushion layer 112 may comprise recycled denim batting material. The recycled denim batting material may comprise post-consumer cotton fibers sourced from denim clothing and textile waste. In some cases, the recycled denim batting material may be treated with borate compounds to provide fire resistance.

In some implementations, the outer cushion layer 112 may comprise recycled carpet fiber material. The recycled carpet fiber material may comprise waste carpet material that has been shredded, filtered, cleaned, and thermally bonded with an olefin fiber binder to form a non-woven material. The waste carpet material may comprise waste from carpet production or unused carpet material from job sites. The recycled carpet fiber material comprises synthetic fibers, which may provide more bounce and springiness compared to cotton-based alternatives such as recycled denim batting material. In some cases, the recycled carpet fiber material may be treated with borate compounds to prevent mold and mildew. The recycled carpet fiber material may have more bounce and springiness compared to recycled denim batting material, providing a softer feel with greater give. The recycled carpet fiber material may be provided in rolls or pads of varying densities and thicknesses to accommodate different comfort and support requirements. The recycled carpet fiber material provides a sustainable alternative to traditional polyurethane foam for cushioning applications.

In some cases, the recycled carpet fiber material may be used as the sole cushioning component without a polyethylene foam inner layer. For example, the recycled carpet fiber material may be used alone in floor seat pads for children. In some implementations, the recycled carpet fiber material may have a density of approximately 2.5 lb/cu.ft. The recycled carpet fiber material may be provided in varying densities and thicknesses to accommodate different comfort and support requirements for each product line. In some cases, the recycled carpet fiber material may be paired with other structural components such as wood bases beneath fabric or vinyl covers.

In some implementations, the recycled carpet fiber material may serve as a sustainable substitute for polyurethane foam in upholstered furniture goods, providing similar comfort and support characteristics while offering environmental benefits. The recycled carpet fiber material may be used in various soft seating furniture applications, including ottomans, lounge furniture, benches, floor seats, and children's seating. In some cases, the recycled carpet fiber material may be used as the primary or sole cushioning component in soft seating products, eliminating the need for traditional foam materials. The bounce and springiness characteristics of the recycled carpet fiber material may allow it to provide comfort and support similar to traditional foam materials, making it suitable as a direct replacement for polyurethane foam in various furniture applications. The use of recycled carpet fiber material in soft seating furniture may support sustainable manufacturing practices by diverting waste carpet from landfills and reducing dependence on petroleum-based foam products.

The outer cushion layer 112 includes a top layer 118 positioned above the inner foam layer 110, a bottom layer 120 positioned below the inner foam layer 110, and a sleeve 122 wrapping around sides of the inner foam layer 110. The sleeve 122 may be formed from a rectangular sheet of material with opposed ends secured together to form a continuous loop. In implementations where the outer cushion layer 112 comprises polyurethane foam, the sleeve 122 may be formed from a rectangular sheet of polyurethane foam with opposed ends sealed together to form a continuous loop. In implementations where the outer cushion layer 112 comprises recycled denim batting material, the sleeve 122 may be formed from a rectangular sheet of recycled denim batting material with opposed ends secured together to form a continuous loop. In implementations where the outer cushion layer 112 comprises recycled carpet fiber material, the sleeve 122 may be formed from a rectangular sheet of recycled carpet fiber material with opposed ends secured together to form a continuous loop.

Based upon the foregoing disclosure, it is seen that the present disclosure provides a cushion structure with improved sustainability and recyclability. The use of polyethylene foam for the inner foam layer allows for easier recycling, while the option of using recycled denim batting material or recycled carpet fiber material for the outer cushion layer further enhances the environmental benefits. The modular design of the cushion structure, with separate inner and outer layers, facilitates disassembly and material separation at the end of the product's life cycle. Additionally, the use of borate compounds for fire resistance in the recycled denim batting material or for mold and mildew prevention in the recycled carpet fiber material offers a non-toxic alternative to traditional chemical treatments.

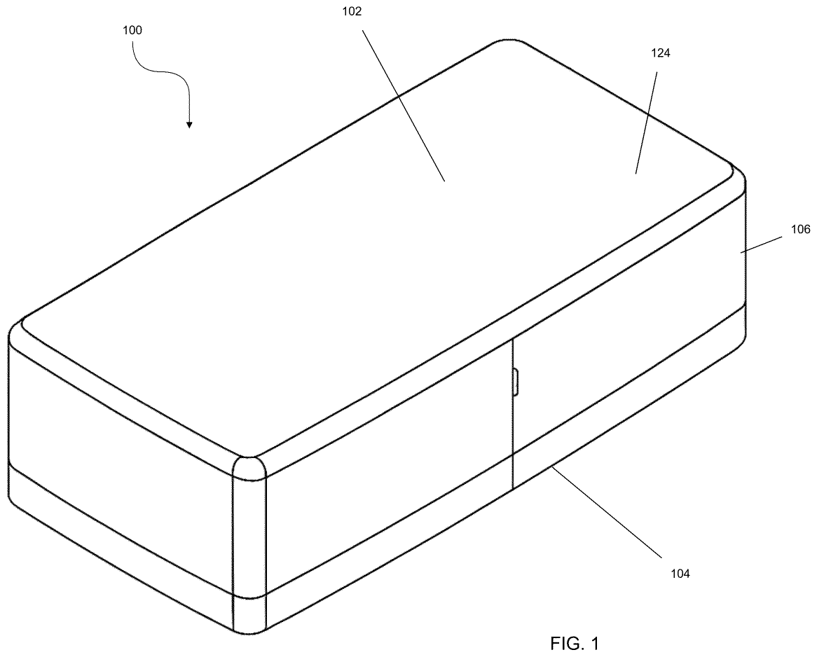

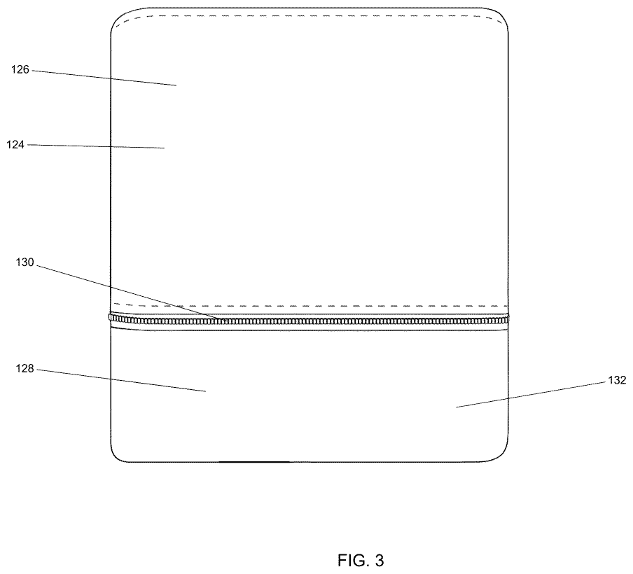

FIG. 1 depicts an isometric view of a seat 100. The seat 100 may include an outer covering 124 encasing the seat 100. FIG. 3 depicts an enlarged view of a lower section of the seat 100, showing additional details of the outer covering 124.

The outer covering 124 may include an upper section 126 and a lower section 128. In some cases, the upper section 126 and the lower section 128 may be joined by a releasable fastener 130. The releasable fastener 130 may extend around a perimeter of the seat 100. In some cases, the releasable fastener 130 may comprise a zipper. However, in other cases, the releasable fastener 130 may comprise hook-and-loop fasteners, snaps, buttons, or other suitable fastening mechanisms.

The lower section 128 of the outer covering 124 may comprise a non-slip surface 132. The non-slip surface 132 may extend up a portion of the sides of the seat 100. In some cases, the non-slip surface 132 may be made of rubber, silicone, or other materials with high friction properties to prevent the seat 100 from sliding on smooth surfaces.

The outer covering 124 may be made from various materials. In some cases, the outer covering 124 may be made from fabric, vinyl, leather, or synthetic leather. The material of the outer covering 124 may be selected based on durability, aesthetics, and ease of cleaning. In some cases, the outer covering 124 may be machine washable. The outer covering 124 may also comprise a stain-resistant fabric to facilitate maintenance and longevity of the seat 100.

The upper section 126 and the lower section 128 of the outer covering 124 may be made from the same material or different materials. In some cases, the upper section 126 may be made from a decorative or aesthetically pleasing material, while the lower section 128 may be made from a more durable or functional material.

The releasable fastener 130 allows for easy removal of the outer covering 124 from the seat 100. This feature may facilitate cleaning, replacement, or access to the internal components of the seat 100. The ability to remove and replace the outer covering 124 may extend the lifespan of the seat 100 by allowing for refreshment of the exterior appearance or replacement of worn coverings.

Based upon the foregoing disclosure, it is seen that the present disclosure provides a seat with an outer covering that offers several advantages. The removable nature of the outer covering enhances maintainability and allows for easy cleaning or replacement. The non-slip surface on the lower section improves safety and stability of the seat. The use of stain-resistant and machine-washable materials in the outer covering contributes to the longevity and ease of maintenance of the seat. Furthermore, the ability to customize the materials of the upper and lower sections allows for a balance between aesthetics and functionality.

The seat 100 may be configured in various shapes and sizes to accommodate different applications and user preferences. In some cases, the seat 100 may have a standard rectangular shape as shown in FIG. 1. The seat 100 may include a top surface 102 for a user to sit on, a bottom surface 104 that may be placed adjacent to a floor, and a sidewall 106 that may extend vertically between the top surface 102 and the bottom surface 104.

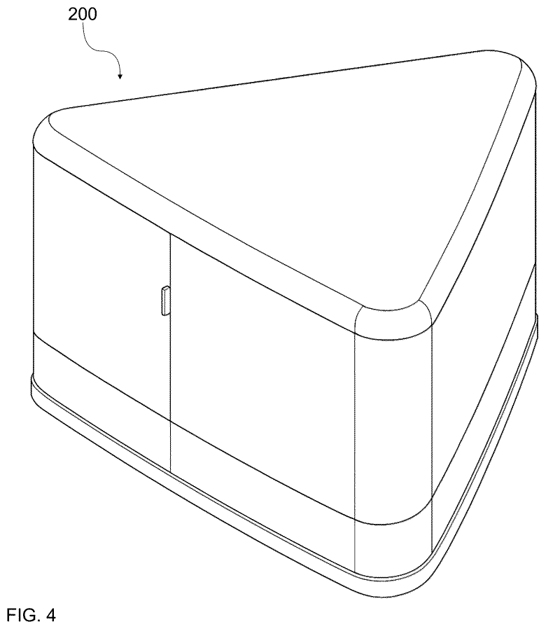

In some cases, the seat may have a triangular shape. FIG. 4 illustrates a triangular seat 200. The triangular seat 200 may feature a top surface that transitions into a curved sidewall, providing an ergonomic design. The triangular shape of the seat 200 may allow for efficient space utilization in corner areas or for creating unique seating arrangements.

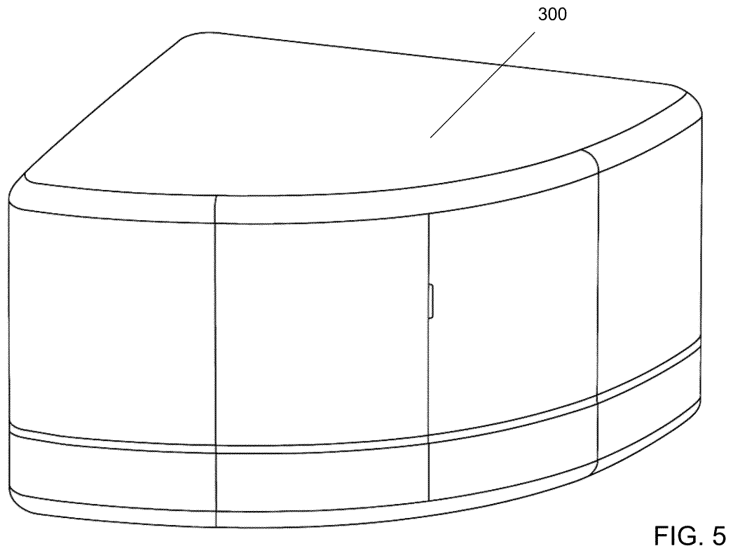

In other cases, the seat may have a rounded corner design. FIG. 5 depicts a seat with a rounded corner 300. The seat with a rounded corner 300 may feature a top surface that transitions into a curved sidewall surface. This configuration may provide a softer, more organic appearance and may be suitable for creating a more relaxed seating environment.

In some cases, the seat may have an elongated bench shape. This configuration may accommodate multiple users or provide additional seating space in various environments.

The seat may include a handle for easy maneuverability. In some cases, the handle may be integrated into the top surface or along the sides of the seat. This feature may enhance the portability of the seat, allowing users to easily move and reposition the seat as needed.

Based upon the foregoing disclosure, it is seen that the present disclosure provides a versatile seating system with multiple configuration options. The various shapes and sizes of the seat allow for adaptability to different spaces and user needs. The inclusion of a handle enhances portability, while the use of ergonomic designs in the triangular and rounded corner configurations may provide improved comfort. The modular nature of the seat design allows for efficient manufacturing and customization, potentially reducing production costs and environmental impact.

FIG. 1 depicts an isometric view of a seat 100. The seat 100 may include a cushion structure 108 and an outer covering 124.

In some cases, the cushion structure 108 may be assembled as shown in FIG. 2. The cushion structure 108 may include an inner foam layer 110 and an outer cushion layer 112. The inner foam layer 110 may comprise polyethylene foam, which may provide structural support and water resistance. In some cases, the inner foam layer 110 may include a plurality of foam layers 116 stacked atop one another. The outer cushion layer 112 may comprise polyurethane foam, which may provide comfort and cushioning.

The outer cushion layer 112 may include a top layer 118, a bottom layer 120, and a sleeve 122. The sleeve 122 may be formed from a rectangular sheet of polyurethane foam with opposed ends sealed together to form a continuous loop. To assemble the cushion structure 108, the sleeve 122 may be placed on an assembly surface with an open top facing upward. The bottom layer 120 may be inserted into the sleeve 122 and positioned near the open bottom. The inner foam layer 110 may then be inserted through the open top of the sleeve 122 and positioned atop the bottom layer 120. Finally, the top layer 118 may be placed within the sleeve 122 and atop the inner foam layer 110. This method of assembly allows the inner foam layer 110 and outer cushion layer 112 to be held together securely without the use of adhesives.

Once the cushion structure 108 is assembled, the outer covering 124 may be placed around the cushion structure 108. As shown in FIG. 3, the outer covering 124 may include an upper section 126 and a lower section 128 joined by a releasable fastener 130. The releasable fastener 130 may comprise a zipper that extends around a perimeter of the seat 100. The lower section 128 may include a non-slip surface 132 that extends up a portion of the sides of the seat 100, enhancing stability and safety.

The inner foam layer 110 and outer cushion layer 112 are held together through the encapsulating design of the outer cushion layer 112, as described in the assembly process. The sleeve 122 of the outer cushion layer 112 surrounds the sides of the inner foam layer 110, while the top layer 118 and bottom layer 120 of the outer cushion layer 112 are positioned above and below the inner foam layer 110 respectively. This configuration creates a secure fit without the need for adhesives, allowing for easy separation of the components for recycling or replacement, while still maintaining structural integrity during use.

To attach the outer covering 124, the cushion structure 108 may be placed inside the lower section 128. The upper section 126 may then be pulled over the top of the cushion structure 108 and secured to the lower section 128 using the releasable fastener 130. This design allows for easy removal of the outer covering 124 for cleaning or replacement.

The combination of the inner foam layer 110 and outer cushion layer 112 may work together to provide both support and comfort. The polyethylene foam of the inner foam layer 110 may offer structural integrity and durability, while the polyurethane foam of the outer cushion layer 112 may conform to the user's body, providing ergonomic support. The removable outer covering 124 may protect the cushion structure 108 and allow for easy maintenance.

Based upon the foregoing disclosure, it is seen that the present disclosure provides a seat that combines comfort, sustainability, and practicality. The seat surpasses the prior art because the use of different foam materials for the inner and outer layers allows for optimal support and comfort while facilitating recycling. The removable outer covering enhances maintainability, and the non-slip surface improves safety. Additionally, the modular design allows for easy disassembly and replacement of individual components, potentially extending the lifespan of the seat.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A seat, comprising:
a cushion structure having:
an inner foam layer comprising polyethylene foam;
an outer cushion layer comprising recycled carpet fiber material; and
a removable outer covering encasing the cushion structure, wherein:
the outer covering includes an upper section and a lower section joined by a releasable fastener; and
the lower section comprises a non-slip surface that extends up a portion of sides of the seat.

2. The seat of claim 1, wherein the inner foam layer comprises a plurality of foam layers stacked atop one another.

3. The seat of claim 1, wherein the outer cushion layer comprises a top layer, a bottom layer, and a sleeve that surrounds sides of the inner foam layer.

4. The seat of claim 3, wherein the sleeve is formed from a rectangular sheet of recycled carpet fiber material with opposed ends secured together to form a continuous loop.

5. The seat of claim 1, wherein the releasable fastener comprises a zipper that extends around a perimeter of the seat.

6. The seat of claim 1, wherein the inner foam layer comprises closed-cell polyethylene foam that provides water resistance and structural support.

7. The seat of claim 1, wherein the inner foam layer and the outer cushion layer are held together without the use of adhesives.

8. The seat of claim 1, wherein the recycled carpet fiber material comprises waste carpet material that has been shredded, filtered, cleaned, and thermally bonded with an olefin fiber binder to form a non-woven material.

9. A seat, comprising:
a cushion structure having:
an inner foam layer comprising polyethylene foam; and
an outer cushion layer comprising recycled carpet fiber material and surrounding and forming a jacket around the inner foam layer without the use of adhesives, the outer cushion layer including a top layer positioned above the inner foam layer, a bottom layer positioned below the inner foam layer, and a sleeve wrapping around sides of the inner foam layer; and
an outer covering encasing the cushion structure, the outer covering including an upper section and a lower section.

10. The seat of claim 9, wherein the polyethylene foam of the inner foam layer is sourced from previously recycled material.

11. The seat of claim 9, wherein the inner foam layer comprises a plurality of foam layers stacked atop one another.

12. The seat of claim 9, wherein the sleeve of the outer cushion layer is formed from a rectangular sheet of recycled carpet fiber material with opposed ends secured together to form a continuous loop, the upper section and the lower section are joined by a releasable fastener comprising a zipper that extends around a perimeter of the seat, and the lower section of the outer covering comprises a non-slip surface that extends up a portion of the sides of the seat.

13. The seat of claim 9, wherein the outer covering is removable.

14. The seat of claim 9, wherein the recycled carpet fiber material comprises waste carpet material that has been shredded, filtered, cleaned, and thermally bonded with an olefin fiber binder to form a non-woven material.

15. The seat of claim 14, wherein the recycled carpet fiber material is treated with borate compounds to prevent mold and mildew.

16. A seat, comprising:
a cushion structure having an outer cushion layer comprising recycled carpet fiber material, wherein the recycled carpet fiber material comprises waste carpet material that has been shredded, filtered, cleaned, and thermally bonded to form a non-woven material; and
a removable outer covering encasing the cushion structure.

17. The seat of claim 16, wherein the cushion structure further comprises an inner foam layer comprising polyethylene foam, and the outer cushion layer surrounds and forms a jacket around the inner foam layer.

18. The seat of claim 17, wherein the inner foam layer and the outer cushion layer are held together without the use of adhesives.

19. The seat of claim 16, wherein the recycled carpet fiber material is thermally bonded with an olefin fiber binder.

20. The seat of claim 16, wherein the recycled carpet fiber material is treated with borate compounds to prevent mold and mildew.
